(19) United States
(12) Patent Application Publication
(10) Pub. No.: US 2009/0254153 A1
(43) Pub. Date: Oct. 8, 2009

(54) Horizontal sauna device

(76) Inventors: Chung Tai Chang, Tainan (TW); Chia Hao Chang, Tainan (TW)

Correspondence Address: Chung Tai Chang, No. 149 (Room 9, 10/F.), Lin Sen Road, Sec.1, Tainan, 704, TW

(21) Appl. No.: 12/080,702

(22) Filed: Apr. 7, 2008

(51) Int. Cl. A61H 33/06

(52) U.S. Cl. 607/83; 4/524

(57) ABSTRACT

A horizontal sauna device mainly includes a controller used to command a positive temperature coefficient thermistor (PTC). The controller has two using modes, a sleep mode and a sweat mode. The maximal power value of the sleep mode is designed with one that is not to make a user awaken by swelter. The sweat mode is allowed to run with a larger maximal power value but strictly limited within a certain period of using time. So, with the sleep mode, a user can comfortably sleep for a long period of time, and with the sweat mode, a user can be prevented from dehydrated as it is restricted in using time.

### BACKGROUND OF THE INVENTION

1. Field of the Invention

This invention relates to a horizontal sauna device able to promote metabolism of one's body and boosting blood circulation, particularly to one able to run under sleep mode and sweat mode, with thermal power conservatively restricted for the sleep mode and with time setting strictly limited for the sweat mode, so as to keep the sauna device running with security and comfort.

2. Description of the Prior Art

As disclosed in Taiwan patents No. 435232 ┌reflecting hood┘ and No. 561897 ┌reflecting hood (2)┘, invented by one of the inventors of this invention, the y are all provided with a frame consisting of plural flexible supporting rods formed as an extendable semi-spiral, and a covering worn on the frame for preventing heat from dispersing out and for reflecting far infrared, and able to be folded and unfolded. When they are unfolded, an interior chamber is formed inside them for a person to lie down therein for being irradiated by a positive temperature coefficient thermistor (PTC) with his (or her) head extending out the covering, able to prevent heat from escaping out and to reflect far infrared, used as a sauna device.

Lying in the sauna device and shined by the far infrared, a person's body can be warmed up to keep on sweating, so as to promote metabolism and reinforce the blood circulation. It is particularly useful for the old or those who move about with difficulty, lowering not only the possibility of illness but social health expenditure. Moreover, a baby can be put in the sauna device to have a comfortable space in winter like being kept in a hospital's warming box, in stead of being often wrapped by a blanket, which may be apt to let the baby feel stuffy and uncomfortable.

The sauna devices are practically advantageous for keeping a body warm and promoting metabolism. However, as the thermal power value and the running time are not assorted or limited for diverse uses, sleeping and sweating, a user may get dehydrated if using too long for sweating, and be awaken because of swelter while sleeping.

### SUMMARY OF THE INVENTION

The object of this invention is to offer a horizontal sauna device.

The main characteristics of the invention are a far infrared positive temperature coefficient thermistor (PTC) and a controller. The controller is provided with two using modes, sleep mode and sweat mode. The maximal power value of the sleep mode is designed with one that is not to make a user awaken by swelter. The sweat mode is allowed to run with a much larger maximal power value but strictly limited within a certain period of using time. So, with the sleep mode, a user can comfortably sleep for a long period of time, and with the sweat mode, a user can be prevented from dehydrated as it is strictly restricted in using time.

### BRIEF DESCRIPTION OF DRAWINGS

This invention is better understood by referring to the accompanying drawings, wherein:

FIG. 1 is a perspective view of a preferred embodiment of a horizontal sauna device in the present invention;

FIG. 2 is a side view of the preferred embodiment of a horizontal sauna device in the present invention, showing it being operated;

FIG. 3 is a block diagram of the circuit of a controller of the preferred embodiment of a horizontal sauna device in the present invention;

FIG. 4 is a top view of the controller of the preferred embodiment of a horizontal sauna device in the present invention; and

FIG. 5 is a perspective view of the preferred embodiment of a horizontal sauna device in the present invention, showing it being folded.

### DETAILED DESCRIPTION OF THE PREFERRED EMBODIMENT

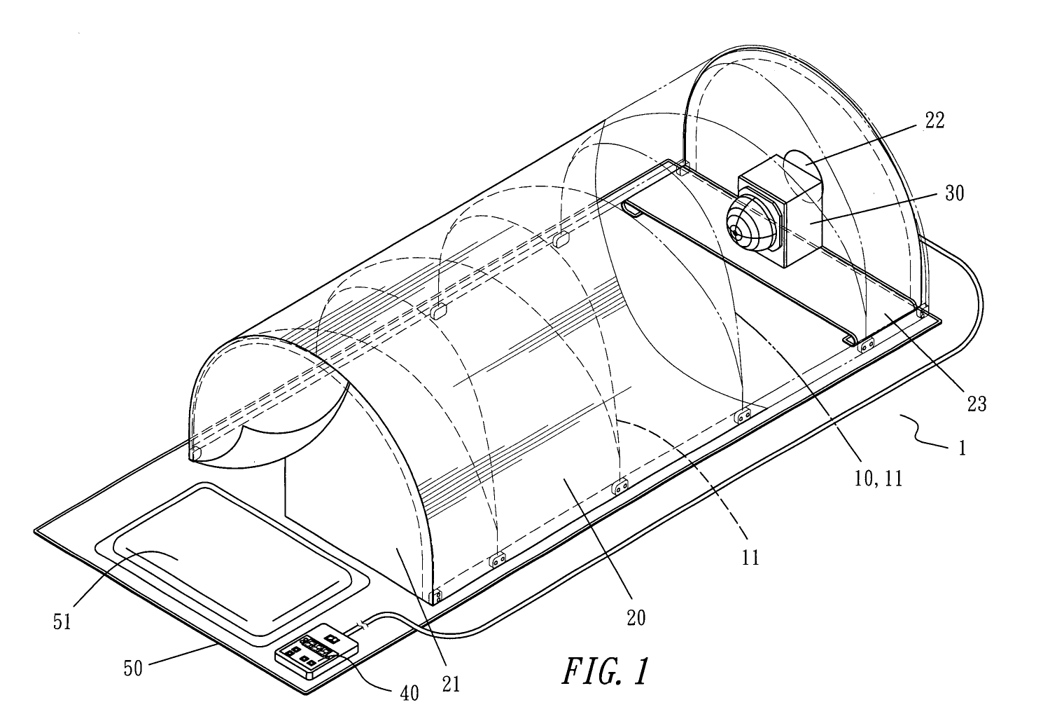

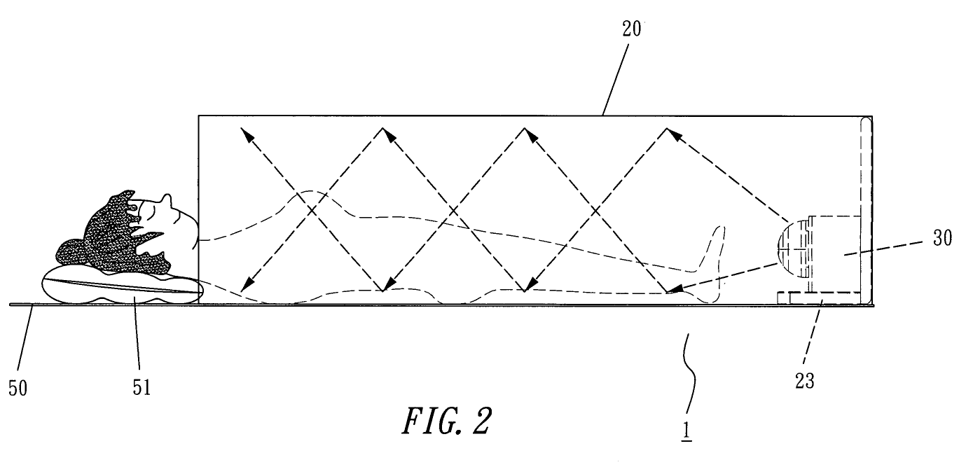

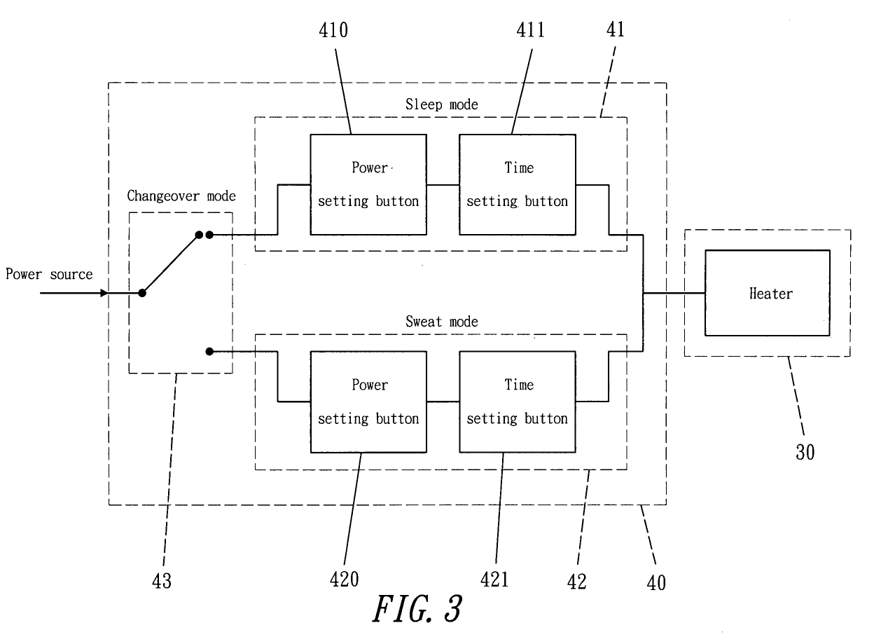

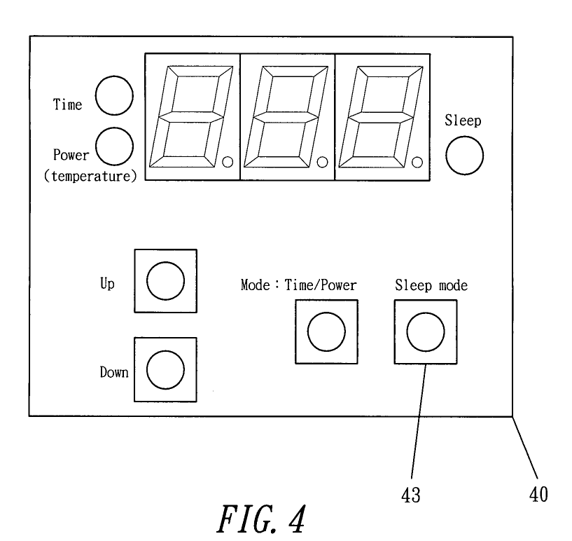

As shown in FIGS. 1˜3, a preferred embodiment of a horizontal sauna device 1 in the present invention includes a frame 10 composed of a plurality of flexible supporting rods 11 formed as an extendable semi-spiral, and a covering 20 fixedly clothed outside the frame 10 for preventing heat from dispersing out and for reflecting far infrared. The combination of the frame 10 and the covering 20 is shaped as a semi-circular tunnel for a person to lie therein, with a head stretching out of it. A curtain 21 is formed at one end of the covering 20 where head extends out and an opening 22 is bored at the other end of the covering 20. Inside the sauna device 1, a heat-resistant flexible supporting cushion 23 is fixed below the opening 22, and a positive temperature coefficient thermistor (PTC) 30 is installed on the flexible cushion 23 to correspond to the opening 22, provided with a fan to draw in air through the opening 22 to blow heat generated in the positive temperature coefficient thermistor (PTC) 30 toward the other side, so as to keep the inside space of the covering 20 continuously warmed up to a constant level by steady thermal circulations, as shown in FIG. 2. And, as shown in FIGS. 3 and 4, the positive temperature coefficient thermistor (PTC) 30 is controlled by a controller 40 built with two modes for different uses, a sleep mode 41 and a sweat mode 42, which are interchanged by a changeover switch 43. The sleep mode 41 and the sweat mode 42 are respectively provided with a power setting button 410 and 420, and a time setting button 411 and 421. The maximal value of the power setting button 410 of the sleep mode 41 is designed under the one that is not to make a person awaken by swelter, such as 150 W; that is, a range between 0 W˜150 W can be optionally selected. The time setting button 411 of the sleep mode 41 can be set free of restriction or timed with an optional term. The power setting button 420 of the sweat mode 42 provides a wider range of power than the sleep mode 41 does, such as 0 W˜1000 W. But, the time setting button 421 of the sweat mode 42 is limited with a maximal period of time, such as one hour.

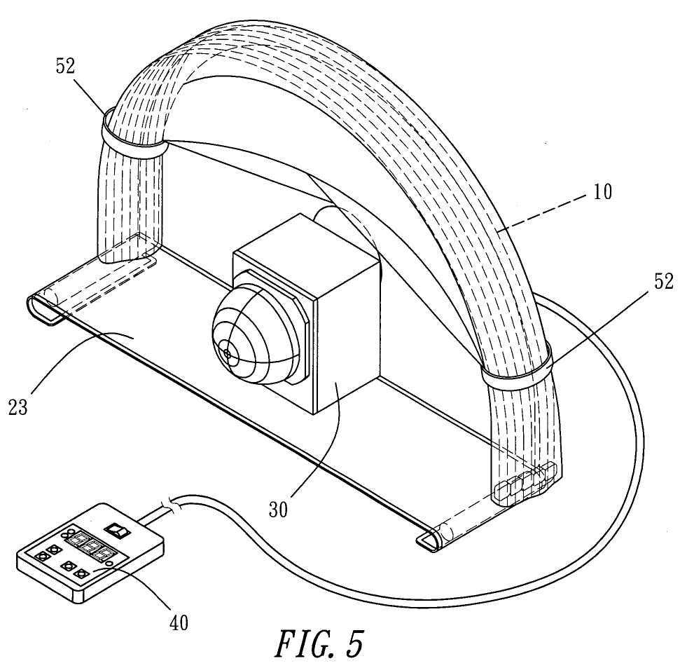

In using, first, the horizontal sauna device 1 is unfolded and laid on a cushion 50, as shown in FIGS. 1 and 2. A pillow 51 having been inflated is put outside the curtain 21. Then, a user can lie down on the cushion 50, with his body lying in the sauna device 1 and his head leaning on the pillow 51 outside the sauna device 1. When the sleep mode 41 is chosen by switching the changeover switch 43, thermal power value commanded by the power setting button 410 is always controlled under a comfortable one. The value available for the power setting button 410 of this embodiment is ranged from 0 W to 150 W. The time setting button 411 can be optionally selected as a user is not to be awaked due to over heat no matter how long he falls asleep. On the contrary, in case that the sweat mode 42 is chosen by the changeover switch 43, the power setting button 420 can widely be ranged; it is set between 0 W˜1000 W in this embodiment. The time setting button 421 is set from several seconds to one hour so as to prevent a user from dehydrating or feeling uncomfortable in an over use. And, as shown in FIG. 5, the covering 20 and the frame 10 can be folded together and tied by two fastening belts 52 in case of not using the sauna device 1.

While the preferred embodiment of the invention has been described above, it will be recognized and understood that various modifications may be made therein and the appended claims are intended to cover all such modifications that may fall within the spirit and scope of the invention.

What is claimed is:

1. A horizontal sauna device comprising a frame that is composed of a plurality of flexible supporting rods 11 formed as an extendable semi-spiral, a covering fixedly clothed on said frame, said frame and said covering assembled together to form as a semi-circular tunnel for a user to lie therein with a head stretching out of it, an opening bored at one end of said covering, a positive temperature coefficient thermistor (PTC) installed inside said sauna device near said opening and provided with a fan able to draw in air through said opening to blow heat generated by said positive temperature coefficient thermistor (PTC) toward another side of said sauna device to maintain a thermal circulation inside said covering, said positive temperature coefficient thermistor (PTC) controlled by a controller, and
said controller characterized by having two using modes that are a sleep mode and a sweat mode, a changeover switch employed to shift between two said modes, each of said sleep mode and said sweat mode provided with a power setting button and a time setting button, said power setting button of said sleep mode provided with a power range that can be optionally chosen and has its maximal value restricted under one that is not to make a user awaken after falling asleep, said time setting button of said sleep mode able to be set free of restriction or timed with an optional term, said power setting button of said sweat mode having a much larger maximal value than that of said sleep mode does, said time setting button of said sweat mode limited in a certain range.

2. The horizontal sauna device as claimed in claim 1, wherein said positive temperature coefficient thermistor (PTC) is based on far infrared.

3. The horizontal sauna device as claimed in claim 1, wherein said maximal value of said power setting button of said sleep mode is 150 W.

4. The horizontal sauna device as claimed in claim 1, wherein said time setting button of said sweat mode is limited within one hour in case that a maximal value of said power setting button is set above 1000 W.
